(19) United States
(12) Patent Application Publication
(10) Pub. No.: US 2009/0070222 A1
(43) Pub. Date: Mar. 12, 2009

(54) VENDOR-QUALIFIED TARGETED MARKETING SYSTEM AND METHOD

(76) Inventor: Gerald Isaac Kestenbaum, New York, NY (US)

Correspondence Address: OSTROLENK FABER GERB & SOFFEN, 1180 AVENUE OF THE AMERICAS, NEW YORK, NY, 100368403, US

(21) Appl. No.: 12/208,857

(22) Filed: Sep. 11, 2008

Related U.S. Application Data
(60) Provisional application No. 60/971,414, filed on Sep. 11, 2007.

(51) Int. Cl. G06Q 30/00; G06Q 40/00

(52) U.S. Cl. 705/14; 705/35; 705/40

(57) ABSTRACT

A system and method for distributing an advertising offer from a provider of goods and services to at least one of a plurality of occupants of a building, In a preferred embodiment, an information processor is accessible by the provider and at least one of the occupants. A first interactive on-line site is provided by the information processor over a global communication network, and the provider sends the offer to the information processor via the first interactive web site. A second interactive on-line site is further provided by the information processor and available only on the private communication network. The offer is respectively distributed to occupant(s) via the second interactive web site according to predetermined rules defined by at least one of the provider, the at least one occupant and a proprietor of the information processor. Further, the provider is restricted from accessing the private communication network and the at least one occupant is restricted from accessing the first site.

### CROSS-REFERENCE TO RELATED APPLICATION

This application is based on and claims priority to U.S. Provisional Patent Application Ser. No. 60/971,414, filed on Sep. 11, 2007 and entitled VENDOR-QUALIFIED TARGETED MARKETING SYSTEM AND METHOD, the entire contents of which are hereby incorporated by reference.

### BACKGROUND

1. Field of the Invention

The present invention relates, generally, to content distribution, and, more particularly, to distribution of content to building occupants.

2. Description of the Related Art

The present invention incorporates by reference in its entirety commonly assigned U.S. patent application, Ser. No. 09/587,525, entitled APPARATUS AND METHOD FOR PROVIDING BUILDING MANAGEMENT INFORMATION.

Vendors of goods and services continually strive to convey to potential buyers various advertisements, including descriptions and prices of the vendors' goods and services. Advertising, typically, is distributed over traditional media channels, including television, radio and various printed materials. More recently, internet-based advertising has evolved as another advertising outlet for vendors to reach consumers.

Compared to the amount of potential revenue to be earned by vendors, many vendors who advertise via prior art media only realize a relatively small return on the large investments made in connection with advertising. Vendors who invest in expensive advertising unfortunately do not often reach the consumers the vendors hoped to target. For example, an owner of a local store who advertises on a local television channel may not reach many people who live within a particular radius of the location of the store. Moreover, those people who see or hear the store owner's advertisement may simply live too far from the store to have any interest in patronizing it. Further, many vendors simply cannot afford to pay for advertising, including, for example, associated with television, radio, print and internet distribution. Thus, the investment made by vendors is often not adequately returned or no sizable profit can be attributed directly to an advertisement. Even if vendors do realize return on advertisement, no effective market research or other target control is realized.

One low-cost alternative to advertising in traditional media is to print flyers and place the flyers where potential consumers may read them. For example, the owner of a restaurant uses his desktop computer and printer to print out one hundred flyers offering a discount coupon for anyone who brings the flyer to the restaurant. This strategy ensures that patrons who redeem the coupon have read the flyer and, accordingly, the restaurant owner has some crude market research feedback regarding the flyer campaign. During distribution, the restaurant owner may place flyers in mailboxes, on car windshields, and may post the flyers at various business establishments when the restaurant owner has received permission.

Although the use of advertising flyers, such as in the above example, may succeed in bringing in some new business, flyers are not often successful for various reasons. For examples, consumers often get inundated by flyers, and eventually stop reading them altogether. Also, many people are inappropriately targeted during flyer campaigns because information regarding the respective recipients is not known by the party who distributes the flyers. Also, typically there is no easy way to determine that a person who receives a flyer is the same person who redeems or otherwise uses the offer. This is largely due to an approach of reaching the broadest range of people as possible. Unfortunately, this approach may be disadvantageous for the provider, as no return on the costs associated with a coupon or other discount may be realized, particularly if the parties using the discounts or coupons are unlikely to return to an establishment for repeat business.

Other shortcomings of advertising campaigns involving the use of flyers contribute are known. For example, people recognize that flyers are a source of pollution and clutter, and many people find flyers to be intrusive and undesirable. Such parties are not likely to read flyers, and instead simply discard the flyers. Typically in the prior art, parties who distribute flyers are paid for the number of people that take the flyers. In other words, the distributors are paid for the number of eyeballs that see the flyers, with no concern over the quality of the receivers or the likelihood of financial return. This is largely because the offers themselves are not tailored or targeted to a particular person or group of people.

### SUMMARY

It is an object of the present invention to provide a system and method for distributing an advertising offer from a provider of goods and services to at least one of a plurality of occupants of a building. In a preferred embodiment, an information processor is accessible by the provider and at least one of the occupants. A first interactive on-line site is provided by the information processor over a global communication network, and the provider sends the offer to the information processor via the first interactive web site. A second interactive on-line site is further provided by the information processor and available only on the private communication network. The offer is respectively distributed to occupant(s) via the second interactive web site according to predetermined rules defined by at least one of the provider, the at least one occupant and a proprietor of the information processor. Further, the provider is restricted from accessing the private communication network and the at least one occupant is restricted from accessing the first site.

Other features are envisioned herein, including, for example, once received, the offer may be modified to specifically identify respective recipients (e.g., building occupants) of the offers. When the offers are redeemed, thereafter, the vendor identifies the respective recipients as a function of the modified offers. Moreover, the vendor preferably uploads the information to the information processor, and the information is, thereafter, compiled into useful formats for review by the various parties. Other features are preferably defined, including defining revenue sharing between vendors and the proprietor in connection with sales made in connection with the offers.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates an example hardware arrangement, in accordance with an embodiment;

FIG. 2 is a block diagram illustrating the functional elements in an example information processor;

FIG. 3 is a diagram that illustrates parties that are associated with an embodiment and preferably communicate via one or more web sites hosted by an information processor in accordance with a preferred embodiment; and

FIGS. 4-6 show example display screens of “dashboard” views that are generated by information processor 12 and displayed for respective parties in connection with the teachings herein.

### DESCRIPTION OF THE EMBODIMENTS

U.S. patent application Ser. No. 09/587,525 (the “525 patent application”), commonly assigned as the present provisional patent application, provides a system and method for providing building management information and/or building-related services, as well as to provide communication between parties who are associated with one or more buildings. Accordingly, tenants, occupants, owners, workers and managers are linked via a central processing computing device and are able to communicate to each other as a function thereof.

In a preferred embodiment, a centralized, on-line and easily accessible tool is provided for vendors or other providers of goods and services to distribute advertising offers, such as coupons or offers to targeted consumers who are preferably building occupants, tenants or residents and who are equipped to receive the offers via a communication network, such as described in the '525 patent application.

As used herein, the term, “module,” refers, generally, to one or more discrete components that contribute to the effectiveness of the systems and methods described herein. Modules can include software elements, including but not limited to functions, algorithms, classes and the like. Modules also include hardware elements, substantially as described below. Modules can operate independently or, alternatively, depend upon one or more other modules in order to function.

As used herein, the terms “link” and “hyperlink” refer to a selectable connection from one or more words, pictures or other information objects to others in which the selectable connection is presented within a web browser software display. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

Also as used herein, the terms “vendor” and “provider of goods and services” are interchangeable, and represent, generally, a party or person who provides goods or services to another, typically, for a fee.

In a preferred embodiment, occupants, residents and/or tenants (collectively, “occupants”) of a building are provided with networked devices that are operable for the occupants to communicate with each other, as well as with building management personnel. For example, and as described in detail in the '525 patent application, occupants of a building receive communications by accessing a computing device, for example, an information processor operating as a internet web server, as known in the art, and by submitting a user name and password. In effect, the occupants “log in” to the information processor. The information processor preferably hosts one or more internet web sites that are directed to one or more respective buildings, and that preferably include web pages designed for occupants or other parties who are otherwise associated with the building. Once logged in, occupants send/receive communications, for example, relating to their building, such as building services, events or the like.

In accordance with a preferred embodiment, the web site hosted by the information processor includes exclusive portions that can be accessed by one or more vendors for particular purposes. For example, a web site hosted by the information processor preferably includes an administrative section of one or more web pages for vendors who provide goods/services. Preferably, a vendor completes an initial registration with the proprietor of the information processor (i.e., a proprietor of the present invention), such as by submitting personal and/or professional information and/or paying a fee. Thereafter, the registered vendor is provided with information for accessing one or more restricted web pages, such as via a secured uniform resource locator (“URL”) that is accessible by the vendor for a period of time. Further, the web site(s) hosted by the information processor may include both shared administrative portion(s) that are designed to accommodate a plurality of vendors, as well as exclusive portion(s) that are designed for exclusive access by individual vendors.

Thus, in accordance with a preferred embodiment, vendors are afforded an opportunity to leverage a building's communication infrastructure, such as defined in the '525 patent application, in order to target consumers whom vendors are trying to reach. In a preferred embodiment, a vendor of goods and services registers with the information processor and submits (e.g., uploads) content, such as advertising content, for distribution to building occupants. The content preferably, but not necessarily, includes incentives such as discounts, coupons, certificates or the like. Further, the content is preferably distributed in accordance with rules defined by the proprietor of the information processor, the vendor or a combination thereof. For example, an advertisement may be distributed on a particular day of the week, during a particular week of the month, or may be distributed only to a target demographic. Moreover, the proprietor of the information processor may define rules for limiting distribution of advertising content in order, for example, to prevent building occupants from being inundated or to prevent certain occupants from receiving inappropriate or redundant content. By enabling distribution rules to be defined and enforced by vendors and/or the proprietor of the information processor, vendors are afforded an increased likelihood that targeted consumers will respond favorably to the vendors' content, thereby resulting in increased business for vendors. Further, building occupants will respond positively because selective advertisements will be tailored towards occupants' respective interests and desires.

In an embodiment, one or more publicly or otherwise accessible displays for residents and/or tenants provide information regarding new vendors, special offers or the like. The display(s) are preferably located in places in a building where people are likely to be, such as in a mailroom, a laundry room, a lobby or the like. Examples of the kinds of information displayed include an introduction to a new restaurant, new retail store, a special sale, or various offers from selected stores. Furthermore, the display(s) may provide information regarding various types of vendors, industries, services and/or merchandise.

In practice and in accordance with one embodiment, each vendor who is a registered user of the information processor is assigned a URL and corresponding storage space on the information processor. The registered vendor preferably uploads content to the information processor, such as an ADOBE PORTABLE DOCUMENT FORMAT (“PDF”) file, and further defines preferred distribution rules, including one or more categories of parties the registered vendor desires to receive the content. For example, the registered vendor submits entries in a data entry display form that includes various graphical screen controls (e.g., drop-down lists, check boxes, radio buttons, push buttons or the like) to make data selections for use by the information processor to distribute the content. Alternatively or in addition, registered users make data entry selections during their initial registration process with the information processor that are stored and used by the information processor to distribute advertising content in the future.

In a preferred embodiment, vendors are evaluated by the proprietor of the information processor prior to registration to determine whether a particular vendor is suitable for becoming a registered user. Alternatively, vendors submit registration request forms to be evaluated for candidacy by a proprietor of the information processor. In one example, vendors personally meet with the proprietor (or representatives of the proprietor) for a preliminary evaluation. The proprietor can, thereafter, make a determination whether a particular vendor is suitable to become a registered user of the information processor. For example, a vendor who sells high-quality and expensive jewelry may be considered to be an appropriate candidate to become a registered user in one building but not necessarily another building. Further, a vendor of large and popular restaurant that is physically located far from a building may be considered an inappropriate candidate to become a registered user of an information processor that services occupants of the building. Thus, preferably an algorithm is employed that factors variables, such as occupant-related demographics, economics, age, cultural qualities or the like, for determining whether a particular vendor is well-suited for registration, and/or for determining respective buildings that a particular vendor is qualified or otherwise authorized to provide advertising content.

Vendors are preferably ensured that, in accordance with the teachings herein, advertising content is appropriately distributed to consumers at least in part by factoring socioeconomic and geographic variables. For example, factors such as whether a building is a rental building versus a co-op, a non-full service building or equipped with a doorman, the location of a respective building, etc., are considered when determining whether advertising content is to be distributed or targeted to various individuals.

As noted above, in a preferred embodiment the advertising content provided by vendors includes incentives to consumers, such as coupons or certificates that, when printed by a consumer, entitles the consumer to a discounted price or other benefit. When a vendor posts advertising content, for example, on the information processor, the vendor includes information regarding an offer, contact information, price quotes, discount or other incentives or the like. Further, an advertisement offer provided by a registered vendor may include a limited offer, such as a significant discount for the first ten consumers who bring a printed copy of a certificate to the vendor's place of business (e.g., the vendor's restaurant, clothing store, jewelry store or other retail establishment). In an alternative embodiment, the number of certificates that are printable is similarly limited. By limiting the number of certificates that can be printed, a potential for fraud, such as a bait and switch tactic by the vendor, is reduced or eliminated.

Preferably therefore, certificates, coupons or other forms of advertising incentives are preferably provided in customized ways to potential customers (or recipients), and various benefits are realized. For example, vendors enjoy customized branding. By ensuring customized certificates, such as printed with a recipient's name or other identifier, a confirmation of the identity of the user of the certificate is provided. Moreover, using a certificate is convenient and enjoyable for users, as a recipient's name, authorization code, contact information or the like is provided on the certificate. Users enjoy a degree of professionalism and prestige by using a customized certificate that is validated or otherwise authorizes the users to special treatment. Moreover, infrastructure limitations are preferably provided, such as by defining a date range, after which a certificate expires, thereby limiting the use and/or transferability of the certificate.

In an embodiment and in addition to pre-qualifying vendors to market in respective buildings, the proprietor of the information processor preferably monitors the number of residents and/or occupants in each building who print certificates, and the proprietor preferably encourages vendors to collect and distribute the certificates to the proprietor, to submit a record of the certificates redeemed by occupants in the information processor, or otherwise inform the proprietor of redeemed certificates so that the proprietor has a record of redeemed certificates. This ensures that appropriate vendors are using the systems and methods described herein, and that the vendors are providing occupants with substantive offers.

In an embodiment, a “dashboard” view is provided via the information processor for registered vendors and/or the proprietor of the information processor to evaluate vendors' relative effectiveness. For example, values representing distribution of advertising content, responses by occupants, redeemed coupons or the like is displayed in a graphical and intuitive format for review. Further, the dashboard preferably displays comparative results that represent vendors' effectiveness in different buildings, or the respective results of different types or sizes of offers.

Moreover, the dashboard interface is useful to continually qualify vendors based on responses from occupants that the vendors receive. Those vendors that receive positive responses may be rewarded, such as by relaxing distribution rules set by the proprietor of the information processor, or by reducing registration fees. Alternatively, those vendors who do not get positive responses from occupants may have their registration rights revoked or otherwise eliminated. In this way, vendors can be pre-qualified, as well as qualifications can be continually monitored and corresponding registrations reviewed.

Thus, as is apparent to one skilled in the art from the teachings herein, the present invention reverses the typical, prior art advertising selling paradigm. Instead of an advertising medium convincing the vendors that their constituent is relevant and valuable to them, the vendors are required to convince the proprietor of the information processor of the vendors' value to the constituent. Accordingly, a novel business method is provided by the systems and methods herein.

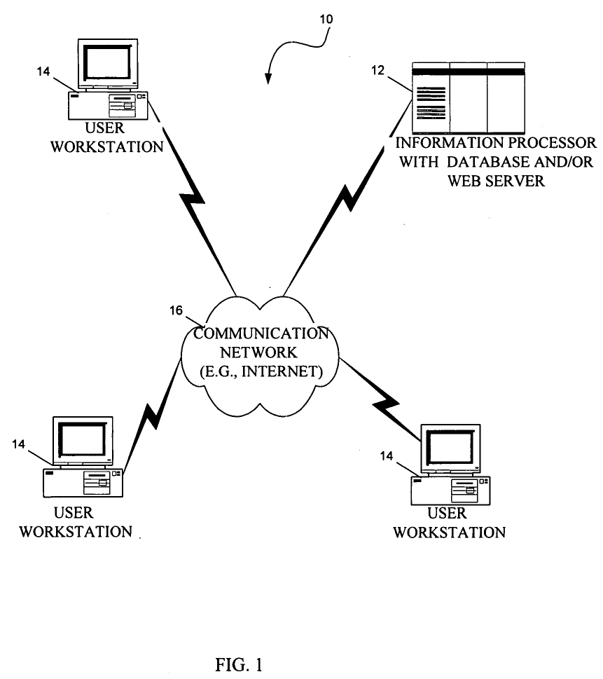

Referring to the drawing figures, in which like reference numerals represent like elements, FIG. 1 illustrates an example hardware arrangement, in accordance with an embodiment, for registering vendors and distributing advertising and promotional offers over a communication network to building occupants, and referred herein, generally, as system 10. In the example shown in FIG. 1, information processor(s) 12 are operable to function as internet web servers, as known to those skilled in the art, and user workstation devices 14 are operated by, for example, building occupants, vendors, building management personnel or the like. Information processor 12 preferably stores information regarding vendors, buildings and occupants, as well as local and regional demographic and business-related information. Information processor 12 preferably includes all databases necessary to support the systems and methods provided herein. However, it is contemplated that information processor 12 can access any required database via communication network 16 or any other communication network to which information processor 12 may be coupled. Communication network 16 is preferably a global public communication network such as the internet, but can also be a wide area network (WAN), local area network (LAN), or other network that enables two or more computers to communicate with each other.

In a preferred embodiment, information processor 12 and user workstation 14 are any devices that are capable of sending and receiving data across communication network 16, e.g., mainframe computers, mini computers, personal computers, laptop computers, a personal digital assistants (PDA), cellular telephones and Internet access devices such as Web TV. In addition, information processors 12 and user workstations 14 are preferably equipped with web browser software, such as MICROSOFT INTERNET EXPLORER, MOZILLA FIREFOX, or the like. Information processors 12 and user workstations 14 are coupled to communication network 16 using any known data communication networking technology.

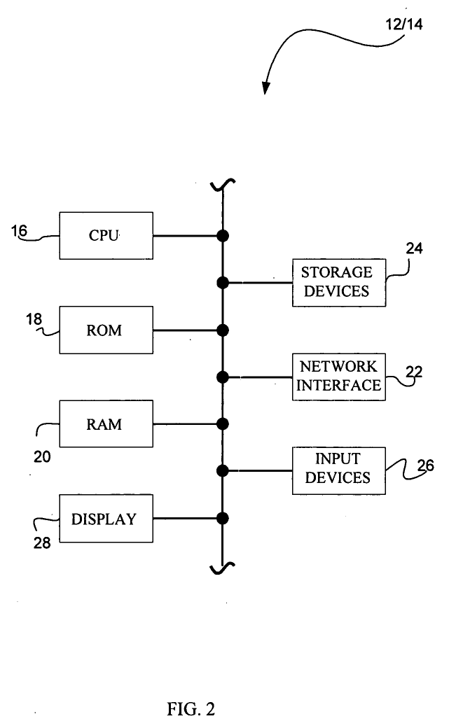

FIG. 2 illustrates the functional elements of an example information processor 12 and/or user workstation 14, and includes one or more central processing units (CPU) 16 used to execute software code and control the operation of information processor 12. Other elements include read-only memory (ROM) 18, random access memory (RAM) 20, one or more network interfaces 22 to transmit and receive data to and from other computing devices across a communication network, storage devices 24 such as a hard disk drive, floppy disk drive, tape drive, CD ROM or DVD for storing program code databases and application data, one or more input devices 26 such as a keyboard, mouse, track ball, microphone and the like, and a display 28.

The various components of information processor 12 need not be physically contained within the same chassis or even located in a single location. For example, storage device 24 may be located at a site which is remote from the remaining elements of information processor 12, and may even be connected to CPU 16 across communication network 16 via network interface 22. Information processor 12 preferably includes a memory equipped with sufficient storage to provide the necessary databases, forums, and other community services as well as acting as a web server for communicating hypertext markup language (HTML), Java applets, Active-X control programs or the like to user workstations 14. Information processors 12 are arranged with components, for example, those shown in FIG. 2, suitable for the expected operating environment of information processor 12. The CPU(s) 16, network interface(s) 22 and memory and storage devices are selected to ensure that capacities are arranged to accommodate expected demand.

The functional elements of information processor 12 shown in FIG. 2 are of the same categories of functional elements present in user workstations 14. However, not all elements need be present in the user workstation 14. For example, storage devices, in the case of PDA's, and the capacities of the various elements are arranged to accommodate the expected user demand. For example, CPU 16 in user workstation 14 may be a smaller capacity CPU than the CPU present in the information processor 12. Similarly, it is likely that the information processor 12 will include storage devices of a much higher capacity than storage devices present in user workstation 14. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, MYSQL, PHP and a plurality of web site development applications.

Although the systems and methods are described by way of example herein and in terms of a web-based system using web browsers and a web site server (e.g., information processor 12), system 10 is not limited to such a configuration. It is contemplated that system 10 is arranged such that user workstation 14 communicates with and displays data received from information processor 12 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on information processor 12 and user workstation 14, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on information processor 12 and user workstation 14 regard the process of communicating data across communication network 16 and processing the data such that the data is viewed on a display 28, for example, by using a web browser and the like. As is known with web browsing software, the display 28 on user workstation 14 presents sites within the system 10 such that a user can proceed from site to site within the system by selecting a desired link.

Therefore, each user's experience with system 10 is based on the order with which he/she progresses through the display screens. Graphical screen controls are preferably available in the display screens and modules to initiate data processes, and to provide convenient navigation between the display screens and modules of system 10. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 10.

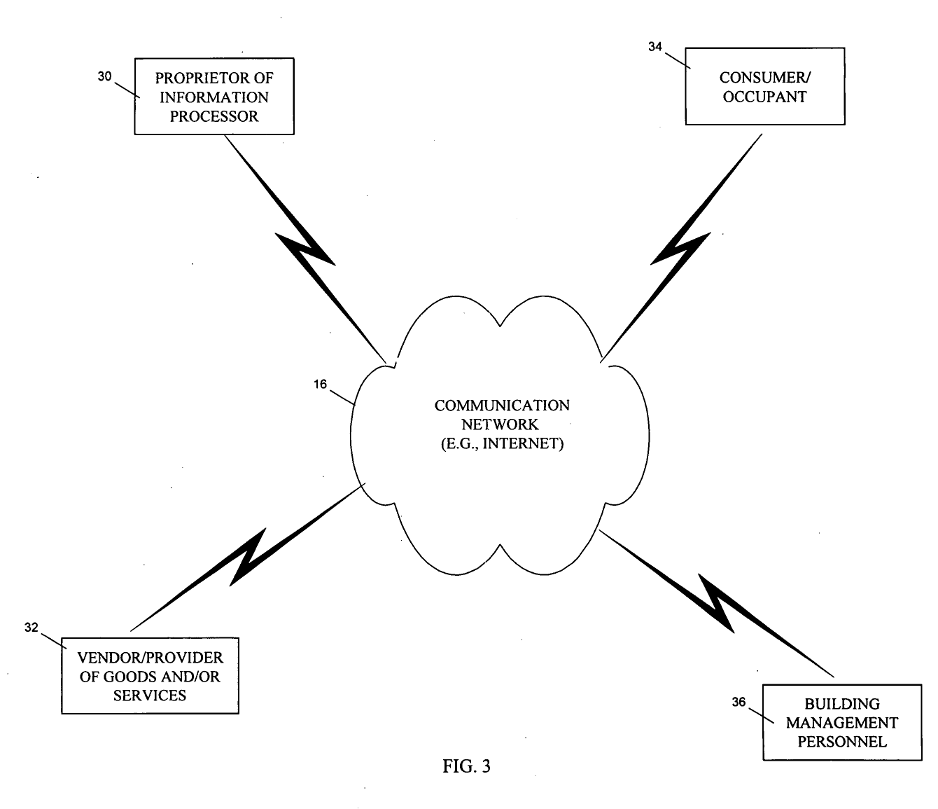

FIG. 3 is a diagram that illustrates parties that are associated with an embodiment and preferably communicate via one or more web sites hosted by information processor 12 in accordance with a preferred embodiment. As shown in FIG. 3, proprietor 30 of information processor 12, vendors/providers of goods/services 32, consumer/occupants 34 and building management personnel 36 access databases and web site(s) that are provided on information processor 12. The databases and web site(s) enable the users 30-36 to submit, receive, distribute, and respond to advertisements and incentives, as described above. The users are preferably trained and supported in the components they have an interest in, thereby enabling them to operate over communication network 16 via information processor 12 efficiently and easily.

In a preferred embodiment, once advertising content (including, for example, discount certificates, coupons or the like) is submitted by a vendor 32 to information processor 12, a hyperlink is provided for occupants 34 that, when selected, displays the vendor's 32 contact information, rates, incentives, coupons or the like in a formatted and aesthetically pleasing way. Further, multimedia content is preferably provided via the hyperlink, such as a short video clip that is narrated by the vendor 32 demonstrating the vendor's 32 goods and/or services. When an occupant 34 elects to print a certificate for redemption, some indicia of the occupant, such as an identification number, bar code, or other identifier is preferably included. When occupant 34 redeems the certificate at the respective vendor's 32 establishment, vendor 32 preferably scans the bar code or otherwise uploads to information processor 12 the identifier of occupant 34. This enables vendor 32 to ensure that the party redeeming the certificate is in fact the party vendor 32 initially hoped to target, and further, may entitle vendor 32 to various rewards from proprietor 30, such as described above. Moreover, by enabling vendors 32 to scan or otherwise identify the recipient of a coupon, certificate or other incentive provided via information processor 12, a form of targeted market research and quality control is provided.

Thus, vendors 32 can effectively and unobtrusively communicate with occupants 34 of respective buildings that are managed by personnel 36 and equipped with building management software, such as described in the '525 patent and maintained by proprietor 30. In accordance with the teachings herein, a personalized and targeted invitation to patronize a vendor's 32 establishment is provided to occupants 34. Unlike prior art spam tactics in which consumers would be reluctant to take advantage of a 10% discount on goods or services, for example, consumers 34 are more likely to respond to the invitation/advertisement because the consumers 34 are appropriate candidates to receive such advertisements. Further, since the present invention supports targeting local consumers 34 (e.g., by street address), registered vendors 32 are more likely to enjoy successful advertising campaigns than non-registered vendors who advertise using prior art methods, such as described above. Thus, consumers 34 feel more comfortable receiving the communications, as well as to take advantage thereof. Vendors 32 are able to target specific buildings in restricted and careful ways via proprietor 30, thereby protect both vendors' 32 and occupants' 34 interests.

Moreover, vendors who provide discounts, coupons or other form of financial incentives are more likely to realize a return on their investments over prior art methods because the coupons, certificates or the like are preferably personalized for the redeemers. Also, vendors can prevent coupons from being transferred or used twice, and thereby eliminate much of the risk associated with prior art distribution of coupons, flyers, etc. Vendors are likely to realize the full benefit of the expenses associated with providing discounted incentives.

Furthermore, in a preferred embodiment, a form of revenue sharing is preferably supported in which vendors 32 submit a portion of revenue received in direct connection with sales associated with the teachings herein from occupants 34. For example, a registered vendor 32 submits information to information processor 12 representing the amount of a sale realized by an occupant 34, as well as the amount of an incentive such as provided by a certificate or coupon. Further, vendor 32 submits the identification (e.g., identification code) of the respective occupant 34. Vendor 32 is preferably charged a portion of the amount of the sale by proprietor 30, and is, accordingly, rewarded thereby, for example, by relaxed distribution rules, reduced registration fees (annual fees, monthly fees, or the like, as defined by proprietor 30). Vendor 32 is not likely to resent the revenue sharing structure because vendor 32 realizes additional sales that vendor 32 would not otherwise have enjoyed. Thus, a novel business method is defined herein wherein vendors 32 and proprietor 30 engage in a revenue sharing structure that is beneficial to each party.

Thus, at least parties 30-34 benefit from the teachings herein. Proprietor 30 benefits by realizing a return on his investment in building management software, including by the revenue sharing structure described above and by charging vendors 32 (and, optionally, occupants 34) registration fees. Vendor 32 benefits by realizing sales that would not have otherwise been made. Occupants/consumers 34 benefit by receiving discounts for goods and services, as well as by receiving exposure to vendors 32 that the occupants 34 might otherwise not have had.

After information is received from respective vendors that represents offers and coupons that were redeemed by building occupants, the proprietor of information processor 12 can track and identify relative successes of particular advertising campaigns. Moreover, the proprietor can track trends in connection with respective buildings, respective vendors and respective industries that participate in the business systems and methods described and defined herein. The proprietor can use the information and statistical analysis thereof in order to make determinations whether particular vendors should be penalized or rewarded based upon overall performance. For example, a vendor who has received a comparatively low percentage of offers that are printed and/or redeemed by building occupants should pay a higher rate than a vendor that enjoys a relatively high percentage of offer redemption. Alternatively, a vendor may be restricted from uploading future advertisements or offers if performance is particularly low.

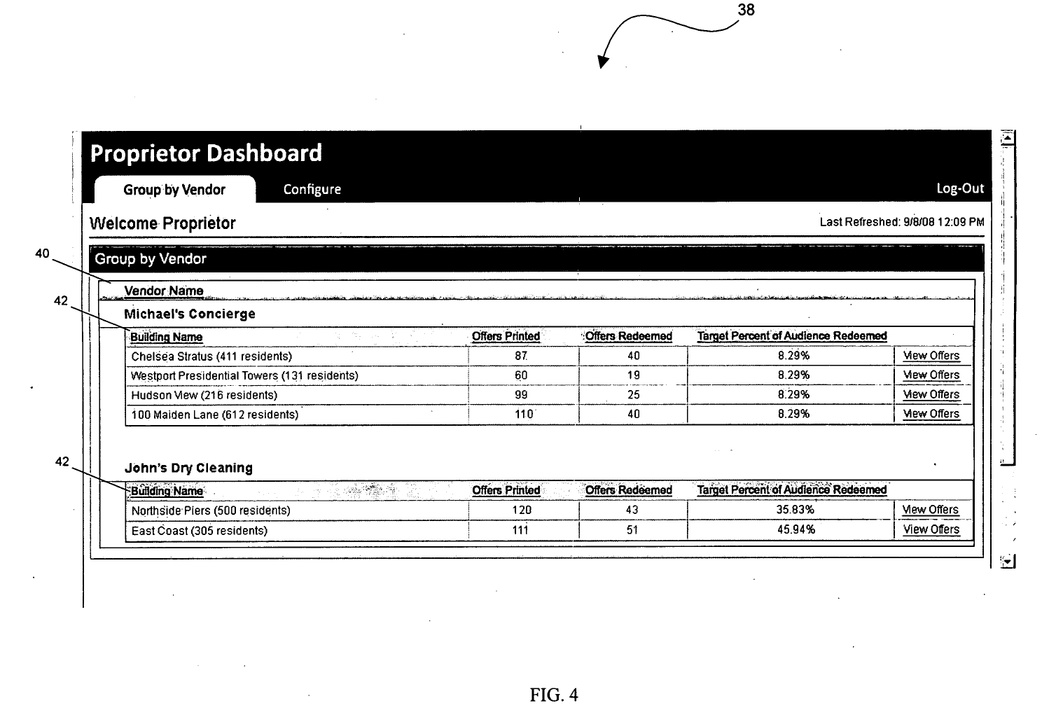

FIGS. 4-6 show example display screens of “dashboard” views that are generated by information processor 12 and displayed for respective parties in connection with the teachings herein.

FIG. 4 illustrates a proprietor dashboard display screen 38 that identifies for a proprietor 30 respective numbers of offers from vendors 32 that are printed and redeemed for respective buildings associated with proprietor 30, grouped by vendors 32. Moreover, example display screen 38 illustrates respective target percentages of audiences (e.g., building occupants) who redeemed particular offers. Furthermore, hyperlinks are provided within example display screen 38 that enable proprietor 30 to select and view respective offers from the vendors 32. In the example shown in FIG. 4, vendor grouping section 40 identifies two vendors: Michael's Concierge and John's Dry Cleaning. These vendors 32 are further shown with buildings grouping section 42 in connection with offers that are distributed to respective buildings in accordance with the teachings herein.

As shown in FIG. 4, Michael's Concierge has distributed to four buildings and John's Dry Cleaning has distributed to two buildings. In accordance with information shown in display screen 38, John's Dry Cleaning has had a greater number of offers that have been redeemed and printed than Michael's Concierge, and the target percentage of audience redemption for the respective offers by John's Dry Cleaning is significantly higher than Michael's Concierge. The example display screen shown in FIG. 4 identifies that convenience that the teachings herein provide for proprietors of information processor 12 in order to identify and review the relative success of particular offers.

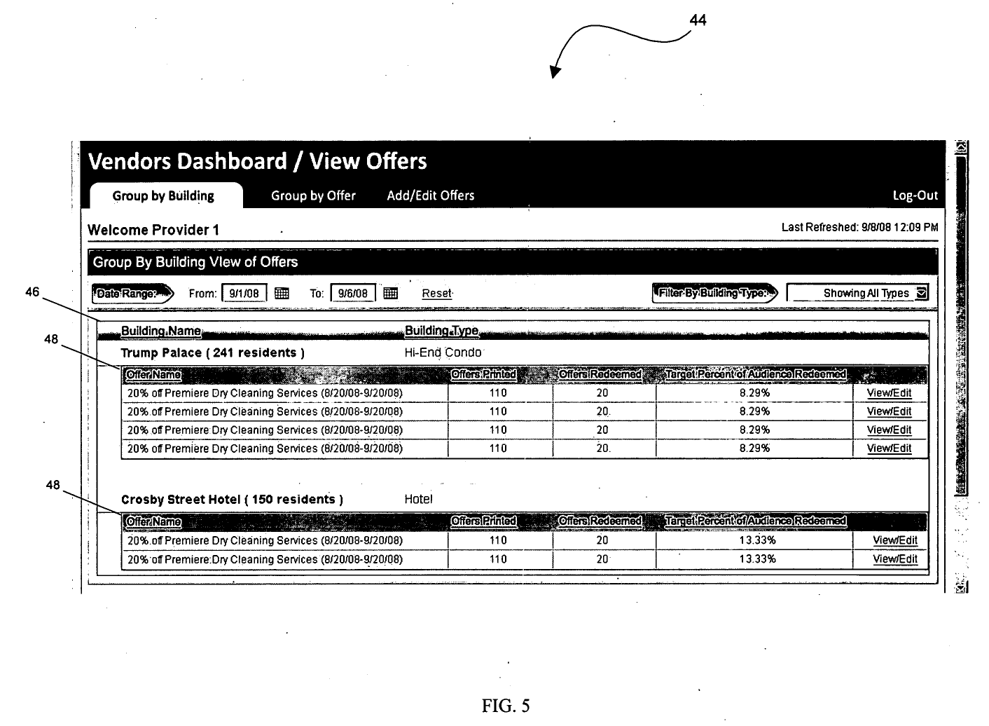

FIG. 5 illustrates a vendor dashboard display screen 44 that identifies for a vendor 32 various information in connection with offers sent from vendors 32 during a particular date range and for a selected building type, grouped by buildings. For example, display screen 44 illustrates the respective names of offers, the number of respective offers printed, the number of respective offers redeemed and the percentage of target audience who redeemed for respective buildings associated with proprietor 30. Moreover, hyperlinks are provided within example display screen 44 that enable vendor 32 to select, view and/or edit respective offers from the vendors 30. Preferably, building grouping section 46 identifies building names and a building type (“Hi-End Condo” in the example shown in FIG. 5).

In the example shown in FIG. 5, two building names are shown: Trump Palace and Crosby Street Hotel. These buildings are further shown with offer grouping section 48 in connection with offers that are distributed to respective buildings in accordance with the teachings herein. As shown in FIG. 5, Trump Palace has had four offers distributed thereto and Crosby Street Hotel has had two offers distributed thereto. In accordance with information shown in display screen 44, Crosby Street Hotel has had a greater number of offers that have been redeemed and printed than Trump Palace, and the target percentage of audience redemption for the respective offers in Crosby Street Hotel is higher than Trump Palace, as well. The example display screen shown in FIG. 5 identifies that convenience that the teachings herein provide for vendors 32 in order to identify and review the relative success of particular offers and particular locations.

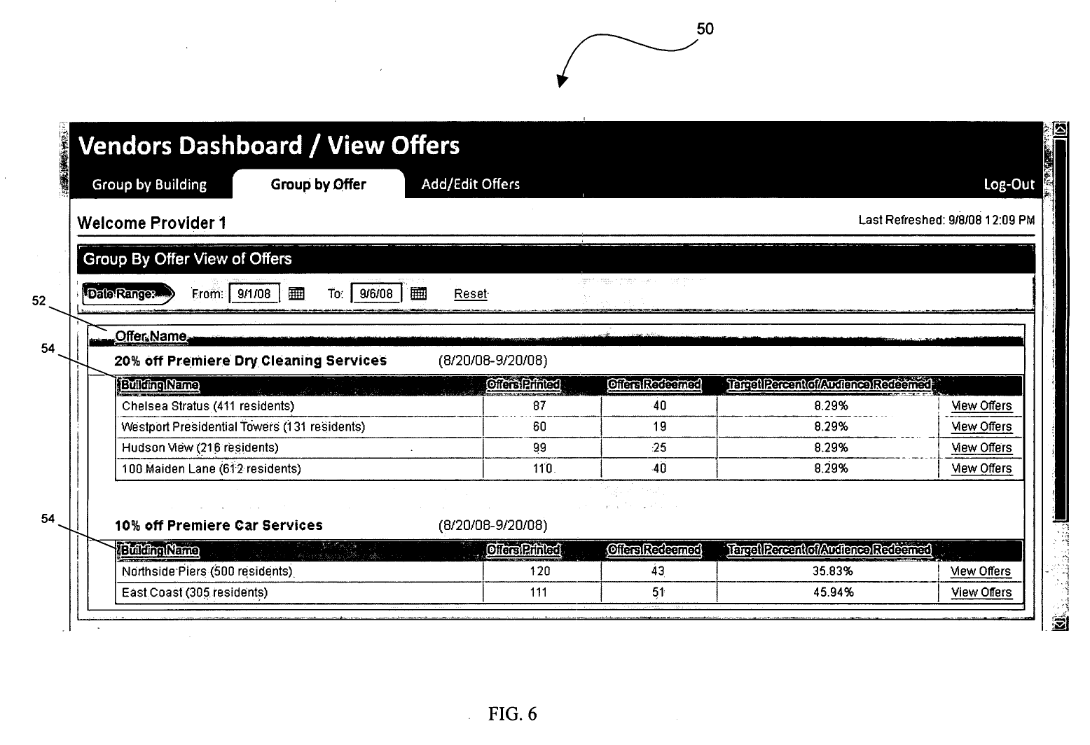

FIG. 6 illustrates another vendor dashboard display screen 50 that identifies for a vendor 32 respective numbers of offers that are printed and redeemed for respective buildings associated with proprietor 30, grouped by offers during a particular date range. Moreover, example display screen 50 illustrates respective target percentages of audiences (e.g., building occupants) who redeemed particular offers. Furthermore, hyperlinks are provided within example display screen 50 that enable vendor 32 to select and view respective offers. In the example shown in FIG. 6, offer grouping section 52 identifies two offers: 20% off Dry Cleaning Services, and 10% off Car Services. These offers are further shown with buildings grouping section 54 in connection with the offers that are distributed to respective buildings in accordance with the teachings herein.

As shown in FIG. 6, the dry cleaning service offer has been distributed to four buildings and the car service offer has been distributed to two buildings. In accordance with information shown in display screen 50, the car service offer has been redeemed more often and printed more often than the dry cleaning offer, and the target percentage of audience redemption is similarly higher. The example display screen shown in FIG. 6 identifies that convenience that the teachings herein provide for vendors 32 to identify and review the relative success of particular offers.

Thus, as shown and described herein, a system and method is provided for distributing an advertising offer from a provider 32 to at least one of a plurality of occupants 34. Preferably, information processor 12 is accessible by the provider(s) 32 and at least one of the occupants 34. Providers 32 preferably send offers to the information processor 12 via a first interactive web site, and the offers are respectively distributed to occupant(s) via a second interactive web site according to predetermined rules.

Once received, the offer may be modified to specifically identify respective recipients (e.g., building occupants) of the offers. When the offers are redeemed, thereafter, the vendor identifies the respective recipients as a function of the modified offers. Moreover, the vendor preferably uploads the information to the information processor, and the information is, thereafter, compiled into useful formats for review by the various parties. Other features are preferably defined, including defining revenue sharing between vendors and the proprietor in connection with sales made in connection with the offers.

Accordingly, the highly personalized printed “offer” is advantageous over prior art offers in that it conveys an offer explicitly made between the store and the particular consumer (who is authenticated by having logged into the intranet). Even consumers who are normally uncomfortable or otherwise avoid being “coupon-clippers” and redeemers are comfortable trying to redeem an offer specifically made to them.

Although the present invention is described and shown in relation to particular embodiments thereof, many other variations and modifications and other uses will become apparent to those skilled in the art. It is preferred, therefore, that the present invention be limited not by the specific disclosure herein.

What is claimed is:

1. A system for distributing an advertising offer from a provider of goods and services to at least one of a plurality of occupants of a building, the system comprising:
an information processor respectively accessible by the provider and at least one of the occupants;
a private communication network and a public communication network accessible by the information processor;
a first interactive on-line site provided by the information processor and available on the global communication network, wherein the provider sends the offer and the information processor receives the offer via the first interactive web site;
a second interactive on-line site provided by the information processor and available only on the private communication network, wherein the offer is respectively distributed to the at least one occupant via the second interactive web site according to predetermined rules defined by at least one of the provider, the at least one occupant and a proprietor of the information processor, and further wherein the provider is restricted from accessing the private communication network and the at least one occupant is restricted from accessing the first site.

2. The system of claim 1, wherein the offer includes a coupon for a good or service sold by the provider.

3. The system of claim 1, wherein the offer is modified by the proprietor to identify the at least one occupant.

4. The system of claim 2, wherein the at least one occupant redeems the coupon and the provider identifies the at least one occupant by the offer.

5. The system of claim 4, wherein the provider sends to the information processor information representing the offer and the at least one occupant who redeemed the coupon via the first interactive on-line site.

6. The system of claim 5, wherein the provider is precluded from accessing the first interactive on-line site as a function of the information.

7. The system of claim 4, further comprising revenue sharing rules for the proprietor and the provider, wherein the provider earns revenue by the redemption of the coupon, and the proprietor receives a portion of the revenue according the revenue sharing rules.

8. The system of claim 1, wherein the rules define distributing the offer according to particular days, times, weeks, building occupant demographics, the nature of the offer or the frequency of distribution of the offer,

9. The system of claim 1, further comprising publicly viewable display screens that display offer information representing the offer via the private communication network to parties other than the at least one building occupant.

10. The system of claim 1, further comprising a third on-line site that is accessible by the at least one occupant and that displays the offer.

11. The system of claim 1, wherein the provider is charged a fee by the proprietor for sending the offer to the information processor.

12. The system of claim 1, wherein the plurality of occupants occupy a plurality of buildings.

13. The system of claim 1, wherein the offer is tracked when the at least one occupant prints or redeems the offer.

14. The system of claim 1, further comprising a formal provider registration, wherein the provider submits provider information to the information processor that represents the provider and the goods and services offered for sale by the provider.

15. The system of claim 14, wherein the proprietor elects to preclude the provider from sending offers to the information processor as a function of the registration.

16. A method for distributing an advertising offer from a provider of goods and services to at least one of a plurality of occupants of a building, the method comprising:
providing an information processor respectively accessible by the provider on a public communication network and at least one of the occupants on a private communication network;
providing by the information processor a first interactive on-line site on the global communication network and a second interactive on-line site on the private communication network, wherein the provider is restricted from accessing the private communication network and the at least one occupant is restricted from accessing the first site;
sending the offer by the provider and receiving the offer by the information processor via the first interactive web site;
defining by at least one of the provider, the at least one occupant and a proprietor of the information processor rules for distributing the offer; and
distributing by the information processor the offer to the at least one respective occupant via the second interactive web site according to the rules.

17. The method of claim 15, wherein the offer includes a coupon for a good or service sold by the provider.

18. The method of claim 17, further comprising modifying the coupon by the proprietor to identify the at least one occupant.

19. The method of claim 17, further comprising redeeming the coupon by the at least one occupant and identifying by the provider the at least one occupant by the coupon.

20. The method of claim 18, further comprising sending by the provider to the information processor information representing the offer and the at least one occupant who redeemed the coupon via the first interactive on-line site.

21. The method of claim 20, further comprising terminating the provider's access to the first interactive on-line site as a function of the information.

22. The method of claim 19, further comprising defining revenue sharing rules for the proprietor and the provider, wherein the provider earns revenue by the redemption of the coupon, and the proprietor receives a portion of the revenue according the revenue sharing rules.

23. The method of claim 16, wherein the rules define distributing the offer according to particular days, times, weeks, building occupant demographics, the nature of the offer or the frequency of distribution of the offer,

24. The method of claim 16, further comprising providing publicly viewable display screens that display offer information representing the offer via the private communication network to parties other than the at least one building occupant.

25. The method of claim 16, further comprising providing by the information processor a third on-line site that is accessible by the at least one occupant and that displays the offer.

26. The method of claim 16, further comprising charging the provider a fee by the proprietor for sending the offer to the information processor.

27. The method of claim 16, wherein the plurality of occupants occupy a plurality of buildings.

28. The method of claim 16, further comprising tracking the offer when the at least one occupant prints or redeems the offer.

29. The method of claim 16, further comprising registering the provider, wherein the provider submits provider information to the information processor that represents the provider and the goods and services offered for sale by the provider.

30. The method of claim 29, further comprising precluding the provider from sending offers to the information processor as a function of the registration.
